(19) United States
(12) Patent Application Publication
(10) Pub. No.: US 2009/0061407 A1
(43) Pub. Date: Mar. 5, 2009

(54) Adaptive Recall

(76) Inventor: Gregory Keim, Broadway, VA (US)

Correspondence Address: GIBSON & DERNIER L.L.P., 900 ROUTE 9 NORTH, SUITE 504, WOODBRIDGE, NJ, 07095, US

(21) Appl. No.: 12/052,435

(22) Filed: Mar. 20, 2008

Related U.S. Application Data
(60) Provisional application No. 60/968,449, filed on Aug. 28, 2007.

(51) Int. Cl. G09B 5/00

(52) U.S. Cl. 434/322

(57) ABSTRACT

The invention relates to a system and methods for determining user knowledge of information, calculating and employing “lag”, i.e., adaptive recall, time for delaying review and testing of the information depending on a user's progress, and/or selecting additional information to be reviewed and tested during the lag time. The present system and methods are adapted to be used in conjunction with conventional and novel computer systems and methods and provides adaptive recall therefor.

### CROSS-REFERENCE TO RELATED APPLICATIONS

This application claims the benefit of U.S. Provisional Patent Application Ser. No. 60/968,449, filed Aug. 28, 2007, the entirety of the disclosure of which application is incorporated herein by reference.

### FIELD OF THE INVENTION

The present invention is directed to a system for and methods of determining user knowledge of information, calculating and employing “lag”, i.e., adaptive recall, time for delaying review and testing of the information depending on a user's progress, and/or selecting additional information for review and testing during the lag time. The method has particular application in teaching a user to learn a new language, although it is not limited to such application.

### BACKGROUND OF THE INVENTION

For various reasons, a person may benefit from review and testing of educational material at varying times and/or in multiple sessions. For example, a person may take time off from learning information. When a person returns to study, the person may have forgotten information and requires review and testing with no delays. Also, information to be learned is typically considered “better” learned if it is in long term memory, rather than short term memory. Thus, in teaching a user information to be learned, it is important to move the information from short term to long term memory. The prior art does not have a manner in which to do this to maximize the efficiency of the learning.

Additionally, a person may know information at a beginner level but not at a desired intermediate, expert, or master level. As such, immediate review and testing is not necessary and may be delayed. As another example, a person may require more review and testing at varying times and/or in multiple sessions than another person employing the same educational material to learn the same information. However, people may find it difficult to measure when and/or how much reinforcement through review and testing is useful. In addition, depending on the desired level of knowledge, people may find it difficult to know when and/or how long to delay review and testing of information that the person knows.

There exist many techniques to test whether an individual is actually learning information. However, there are no known techniques for accurately determining when and/or how much a person needs review and testing of information and/or if review and testing of some information may be delayed depending on the degree of a person's knowledge of the information. There also exists no known methodologies for carefully moving the information from short term to long term memory as the user's learning is detected to be properly progressing.

Therefore, there is a need in the art for determining how much and when review and testing are necessary and employing delays for review and testing of information depending upon a person's level of knowledge of the information.

There is also a need in the art for an efficient method of learning various items of information that are interdependent, and for gradually moving such items from short term memory through to long term memory in an efficient, optimized, manner.

### SUMMARY OF THE INVENTION

In accordance with at least one aspect of the present invention, a method for adaptive recall is disclosed for determining a user's knowledge of an item of information and calculating and employing a lag time for review and testing of the item. In accordance with one or more embodiments, when controlling the educational progress of a user, “lag” or adaptive recall time is used to teach the user at various times and/or in changing intervals of time and difficulty.

In accordance with at least one embodiment, the method further includes receiving a desired level of knowledge from a user. In accordance with at least one embodiment, a user's knowledge may be more than binary as a user's knowledge may have different levels and dimensions. For example, a word or phrase being learned in a foreign language may be known in context, out of context, only enough to speak it if shown an image of what the word means, enough to produce it spontaneously like in one's native language, written, etc. Additionally, the level of knowledge may have differing speeds for each skill, that is, ability to answer immediately, or requiring a long delay.

As a user becomes more proficient with certain information, subsequent review and testing of the information may be increasingly delayed, i.e., lag or adaptive recall time increases, or eliminated. In addition, knowledge of new information may reinforce or supplement related previously-presented information and can result in an increased lag time. In accordance with one or more embodiments, a method of the present invention can evaluate the user's responses to tested questions for previously-presented material and determine the lag time needed for proceeding with the user's educational progress. In accordance with at least one embodiment, testing may be done through any method known to those skilled in the art, such as, but not limited to, multiple choice tests, question and answers, verbal recitations, matching, speech-based testing, writing-based testing, transitional testing, or the like.

In another embodiment, a method assesses a test of a user's knowledge of an item with multi-level variables, such as, but not limited to, time delay, pronunciation, number of guesses, choices guessed, number of times user has seen an item before, whether the answer is correct or incorrect, elapsed time of response, writing, grading, whether path level assessment is involved, or the like. For example, an adjustment of lag and dependency selection may be based upon whether a user knows the item at least to an expert level. In one embodiment, if a user answers the questions well, then lag time would increase. In another embodiment, if a user answers the questions poorly, then lag time would decrease. In a further embodiment, if the user requires immediate review and testing, then the lag time is adjusted accordingly, i.e., reduced to zero or eliminated for at least one phase. In yet a further embodiment, lag time for a lesson is adjusted to account for the fact that a lesson requires more time than the user is available or to account for the fact that a lesson is subject to at least a rule governing at least a sequence of information.

In accordance with another aspect of the present invention, a method for adaptive recall is disclosed for determining a user's knowledge of a first item of information; calculating and employing a lag time for delaying review and testing of the first item; and selecting at least a second item for review and testing that can be accomplished during the lag time. In accordance with at least one embodiment, selection of at least a second item for review and testing includes consideration of lag time of a first item and/or dependencies and/or rules. For example, certain items may not be selected until other items are known by the user. In accordance with at least another embodiment, each different type of knowledge is used in setting lag times and/or dependencies and/or rules. The lag time for a first item that is a word or a phrase may change if at least a second item that is a word in the phrase or is a word that may be confused with a word in the phrase is tested during the lag time. If similar sounding and/or looking items, such as, but not limited to, spelled words are tested during the lag time, the lag time is decreased to account for the fact that the user's knowledge of the item may be called into doubt. In some embodiments, lag time may be increased to allow review and testing of a selected second item to finish when taking longer than the lag time of the first item.

In accordance with yet another aspect of the present invention, a system is disclosed for adaptive recall including at least a processor; at least a memory coupled to the processor; at least an input device coupled to the computer system; and one or more programs encoded by the memory, the one or more programs causing the processor to determine a user's knowledge of a first item of information; calculate and employ a lag time for delaying review and testing of the first item; and/or select at least a second item for review and testing that can be accomplished during the lag time. In accordance with at least one embodiment, one or more programs exist in real-time. In accordance with at least one embodiment, one or more programs create and update a user model to track a user's performance and history on selected content through time. In one embodiment, a user has the option to skip and/or delay review and testing to learn new items. In at least one embodiment, a user can quit the one or more programs at any time. In yet a further embodiment, a user can continue reviewing and testing previously-presented items as the user desires.

The system may also include adjusting lag time and/or difficulty of a test by factoring in a usage time of the user obtained from the user at the beginning of a user session or from normal usage patterns of the user stored in a user model. In at least one embodiment, the user model creates a user path and/or teaches one or more phases of one or more items of information to a user. The system may also include a lag core engine adapted to power and/or at least partially control review and testing for one or more programs. In a further embodiment, the lag core engine customizes a user path or the one or more programs for the user.

Other aspects, features, advantages, etc. will become apparent to one skilled in the art when the description of the invention herein is taken in conjunction with the accompanying drawings.

### BRIEF DESCRIPTION OF THE DRAWINGS

For the purposes of illustrating the various aspects of the invention, wherein like numerals indicate like elements, there are shown in the drawings simplified forms that may be employed, it being understood, however, that the invention is not limited by or to the precise arrangements and instrumentalities shown, but rather only by the issued claims. The drawings may not be to scale, and the aspects of the drawings may not be to scale relative to each other. To assist those of ordinary skill in the relevant art in making and using the subject matter hereof, reference is made to the appended drawings and figures, wherein:

FIG. 1 is a flowchart view of an embodiment of a method for adaptive recall in accordance with at least one aspect of the present invention.

FIG. 2 is a flowchart view of an embodiment of a method for adaptive recall involving a dependency and a rule in accordance with at least one aspect of the present invention.

FIG. 3 is a flowchart view of an embodiment of a binary test employing adaptive recall in accordance with at least one aspect of the present invention.

FIG. 4 is a view of an embodiment of a non-binary multiple choice test employing adaptive recall in accordance with at least one aspect of the present invention.

FIG. 5 is a flowchart view of an embodiment of a system program employing an adaptive recall core engine in accordance with at least one aspect of the present invention.

FIG. 6 is a flowchart view of an embodiment of a system employing adaptive recall for a user model in accordance with at least one aspect of the present invention.

FIG. 7 is a flowchart view of an embodiment of a system employing adaptive recall including a user interface in accordance with at least one aspect of the present invention.

FIG. 8 is a view of an embodiment of a user model teaching information in phases in accordance with at least one aspect of the present invention.

FIG. 9 is a view of an embodiment of tests for transitioning from one phase to another phase in accordance with at least one aspect of the present invention.

FIG. 10 is view of an embodiment of a pronunciation test with context in accordance with at least one aspect of the present invention.

FIG. 11 is a block diagram of an embodiment of a system in accordance with at least one aspect of the present invention.

FIG. 12 depicts a table with an example of adjusting certain factors based upon performance of a user in accordance with the present invention.

### DETAILED DESCRIPTION OF THE PRESENT INVENTION

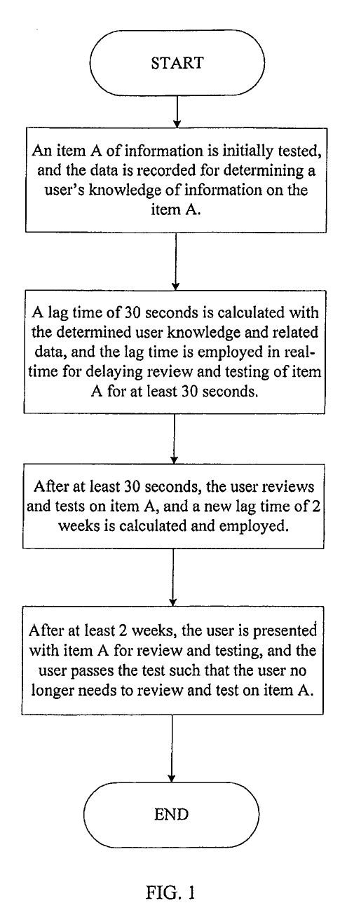

Now referring to FIG. 1, in general, systems and methods are disclosed for employing varying “lags”, i.e., adaptive recall. In particular, the present invention relates to systems and methods for determining user knowledge of information, calculating and employing lag time for delaying review and testing of the information depending on a user's progress, and/or selecting additional information for review and testing during the lag time.

In accordance with at least one embodiment, new items of information are reviewed in an initial lesson and test or an initial test to obtain data to calculate a first lag time. Old items of information each have a calculated lag time from an initial test and, therefore, were reviewed during the initial test. In some embodiments, an item of information may be reviewed and/or tested. In other embodiments, an item of information may be tested without more review. In further embodiments, an item of information may be reviewed without testing.

In accordance with at least one embodiment, as shown in FIG. 1, determination of a user's knowledge of information occurs when an item “A” of information is tested, e.g., a user pre-test, and the received data from a user is recorded. In accordance with another embodiment, determination of a user's knowledge of information occurs when a user records the user's knowledge of the information. In some embodiments, a user may provide the user's general level of knowledge, such as, but not limited to, beginner, intermediate, expert, master, or the like. In some embodiments, a user may provide the user's knowledge on a form; during an orientation, meeting, and/or interview; or the like.

In accordance with at least one embodiment, a method of adaptive recall includes testing a user for knowledge of an item that may encompass any type of information available. An item of information defines at least a portion of what a user must know to learn desired information. An item of information, such as, but not limited to, a vocabulary word, verb conjugation, sentence structure, an idiom, an inflection, a phrase, a grammatical rule, a mathematical rule, subject-related information, an embodiment of a skill, or the like, is tested. Some embodiments of subject-related information include, but are not limited to, language, grammar, math, history, science, trivia, or the like. Some embodiments of a skill include, but are not limited to, alphabet recognition and/or reproduction, pronunciation, intonation, question asking, fact retention, problem solving, task-related, or the like. In accordance with at least one embodiment, at least an item of information is pulled from a generic and/or independent pool of information, i.e., a user learning an item is not dependent on the user learning another item first. In accordance with other embodiments, an item of information is dependent on learning another item of information first. As in FIG. 1, a user is tested on information, such as, but not limited to, a spoken language, a written language, text, sounds, or the like.

In accordance with at least one embodiment of the present invention, a method is disclosed for determining user knowledge of information with at least a test, calculating and employing lag time for delaying review and testing of the information, and selecting additional information for review, and testing during the lag time. In some embodiments, no more additional information exists to be learned by a user. In accordance with at least one embodiment, the decision between selecting additional items of information and reviewing and testing the first item of information includes at least the equation that calculates the lag time, i.e. minimum amount of time between a previous testing and a subsequent review and testing of an item of information.

In at least one embodiment, again referring to FIG. 1, lag time is calculated with the recorded data from the user's response to an initial test, and the lag time is employed in real-time for delaying the review and testing of the item. As in FIG. 1, lag times of thirty seconds and two weeks were calculated and employed for delaying review and testing of item “A” after two adaptive recall intervals, respectively. After the second test, the user passes the test and no longer needs to review and test on item A. The data from the user's response, such as, but not limited to, number of correct answers, number of incorrect answers, speed of responding, the number of times the user has seen the item, or the like, are used to calculate and employ a lag time that must elapse before the user reviews and is tested again on the original item. In accordance with at least one embodiment, a lag time equation results in a longer lag time when a user tests incorrectly and results in a shorter lag time when a user tests correctly. For example, for a correct response, the lag time may double in time whereas for an incorrect response a lag time may be reduced by half the time. If a user has just seen an item for the first time, and if the user gets the answer(s) wrong, the lag time might be just a few seconds to a minute, or the like. On the other hand, if the user has seen an item multiple times before and has responded correctly each time, then the lag time might be a few weeks, months, years, or the like. In some embodiments, a lag time equation may change on a per user basis. In accordance with at least one embodiment, the lag time is assigned in real-time. As in FIG. 1, if an item “A” has a lag time of 30 seconds or 30 minutes for example, then item “A” will return at that time or at the earliest moment that the user uses the program after the lag has elapsed. Or, if the system determines, through specific user input or past practice, that the user is likely to complete using the system before the lag time has elapsed, the system may return item A for before completion of using the system, and it optionally may use a more difficult test for item A to account for the fact that it is returning it to the user sooner than it should be so returned, based upon the user's knowledge level.

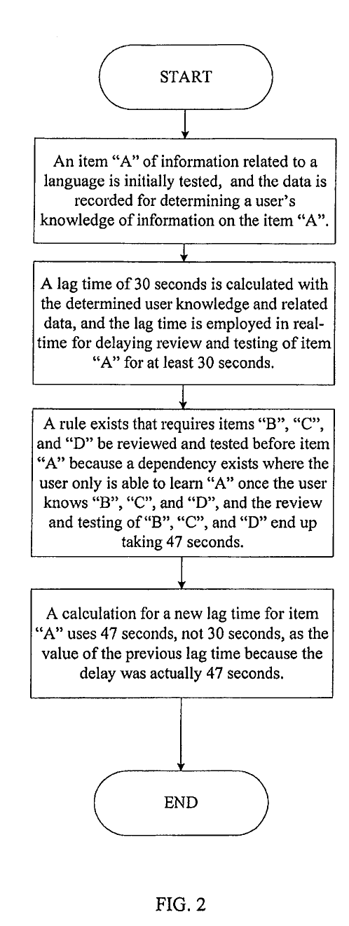

In accordance with some embodiments, as shown in FIG. 2, after a lag time is calculated, the review and testing of an item of information may be subject to at least a rule governing the sequence of information, i.e., determining when, after the lag time has elapsed, an item of information is presented to a user for review and testing. In accordance with at least one embodiment, there may be at least a rule governing item testing, such as, but not limited to, a rule about the maximum number of times an item of information is reviewed and tested before the user is finished learning the item, a rule governing the ratio of reviewing old items of information to new items of information with which the user will be presented, a rule about which way an item of information is reviewed by the user, a rule that determines the ease or difficulty of the mode in which the item of information is reviewed, or the like. Again referring to FIG. 2, a user has seen item “A” for the first time and gotten the test wrong. As such, calculated lag time is thirty seconds. However, according to a rule of sequence information delivery, items “B”, “C”, and “D” must be reviewed and tested before item “A” is reviewed and tested. Thus, positioned in an information queue, item “A” actually is reviewed and tested after forty-seven seconds, not thirty seconds. Subsequent calculations for a new lag time will then use forty-seven seconds, not thirty seconds, as the previous lag time for the calculation of the next lag time. In another embodiment, items “B”, “C”, and “D” finish review and testing before 30 seconds elapses for the lag time of item “A”. In yet another embodiment, the same lag time calculation and employment process occurs for the other items “B”, “C”, and “D” being reviewed and tested, and an infinite variety of possible information sequence deliveries can result. Generally, the system may adjust the lag time based upon the need to first test other items, or may adjust which items are tested based upon the lag time for testing another item.

As shown in FIG. 2, after a lag time is calculated, the review and testing of an item of information may be subject to at least a dependency in addition to at least a rule and/or the lag time. In accordance with at least one embodiment, a method selects and teaches a user the dependent items in various ways as to how each dependent item relates. Now referring to FIG. 2, an embodiment includes dependent items “A”, “B”, “C”, and “D”. In order to learn “A”, a user must know “B”, “C”, and “D”. Thus, based on the prerequisites, i.e., dependencies, rules, or the like, for “B”, “C”, and “D” a test can choose a next item to introduce that builds off of the required user knowledge, such as item “A”. Those skilled in the art will recognize that some embodiments pertain to, but are not limited to, learning languages.

A lag time may also account for a user's potential exposure, outside of the system, to particular items of information to be learned. For example, if the system sets a lag time of ten hours, it may adjust that lag time up if, by monitoring the user's computer usage, it determines that the user has actually been exposed to the word during the lag time through some other source, such as visiting websites, playing computer games, etc.

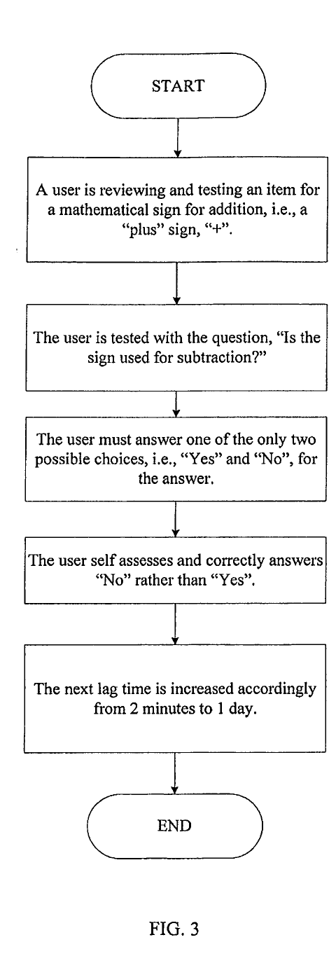

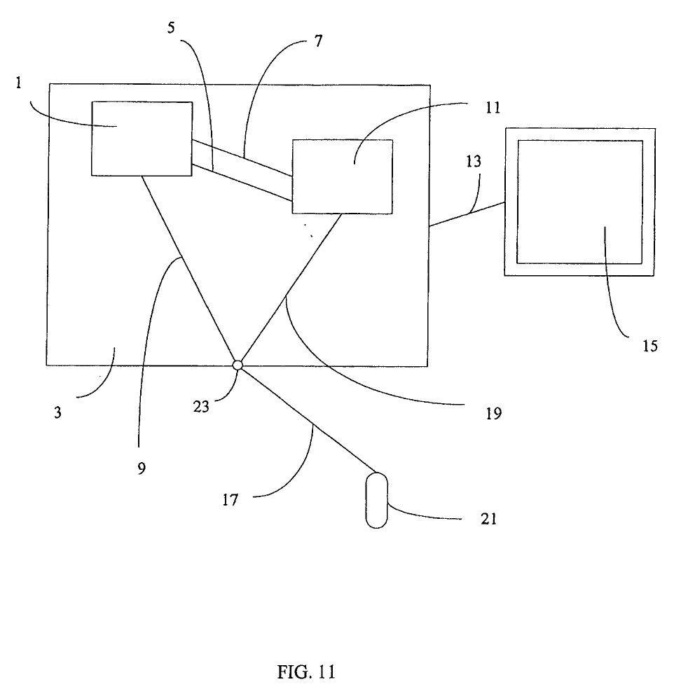

In accordance with at least one embodiment, a test includes binary assessment and/or non-binary assessment when grading a user for knowledge of an item. As an example of binary assessment, now referring to FIG. 3, a user is presented with an item “+“representing a mathematical addition sign, i.e., a “plus” sign, and is tested with the question, “Is the sign used for subtraction?” The only two choices for answers are “yes” and “no”. The user self assesses and correctly responds “no” rather than “yes”. The next lag time is increased accordingly from 2 minutes to 1 day. In at least one embodiment, the test scores a user based upon user responses. While grading a user, a test automatically assesses the user's knowledge of an item, such as, but not limited to, matching items, pronouncing items, i.e. speech-based testing, writing items, or the like. The user does not need to self assess. However, in some embodiments, a user may self assess. A test only questions a user on information for which there is a right answer, and therefore, the test always identifies when a user answered correctly, such as, but not limited to, through a binary test, as shown in FIG. 3, or with a phoneme model of a correct phrase using a speech recognition system as with a microphone shown in FIG. 11.

In at least one embodiment, a test employs a broad set of information about how the user did on the test when performing non-binary assessment. Now referring to FIGS. 1-2, for non-binary assessment, a variety of novel factors are used, such as, but not limited to, delay in initial response, elapsed time of response, writing grading, speech recognition, or the like. Delay in initial response includes, but is not limited to, time taken to start clicking on a picture, text, and/or sound; time taken to start talking, writing, and/or tiling; or the like. Elapsed time of response includes, but is not limited to, time taken to finish clicking on an answer, time taken to finish talking, writing, tiling, or the like. Writing grading and speech recognition, include, but are not limited to, assessing dimensions of accent, pacing, intonation, pitch, nativeness, stress, spelling, punctuation, capitalization, number of mistakes, edit distance from the answer, or the like. Other variables that may be used include, but is not limited to, the number of additions, deletions, substitutions, or the like, to get the answer correct. In some embodiments, each factor may have a single, combined score for all factors. In other embodiments, each factor may have several grades measuring different dimensions or phases of testing at the same time. When dealing with timing, faster responses are graded higher than slower responses. In some embodiments, timing may be calibrated to the speed of native speakers when utilizing language and/or speech tests. In at least one embodiment, a baseline time for each activity is used to grade a user for closeness to the user's desired level of knowledge.

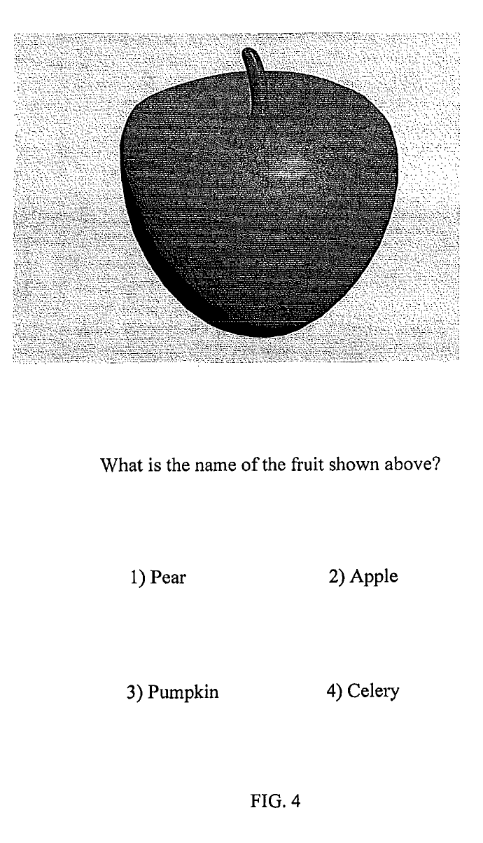

In accordance with at least one embodiment, a test includes active and/or passive assessment of user mistakes to obtain additional information as to what users do not know. In accordance with at least one embodiment for a non-binary test using active and passive assessment, a test can passively test N items while actively testing 1 item. N is a random integer, such as, but not limited to, 1, 4, 6, or the like. Now referring to FIG. 4, where N is 3, a user is presented with an image of an apple and asked to select the correct label for the fruit out of four options: “Pear”, “Apple”, “Pumpkin”, and “Celery”. If a user picks choice 1 for “Pear” when choice 2 for “Apple” is the answer, the test actively assesses that the user does not know choice 2 for “Apple” and passively assesses that the user does not know choice 1 for “Pear”. Because the user is confused with one answer over another, the user provides more information about the level of knowledge for the tested items. User model for items 1 and 2, “Pear” and “Apple, respectively, receives a small change in the negative direction indicating that the user requires more review and testing for items 1 and 2. Additionally, because the user did not pick choices 3 or 4, i.e., “Pumpkin” or “Celery”, respectively, the user is not confused that those items resemble an apple. As a result, user model for items 3 and 4 receives a small change in the positive direction indicating that the user requires less review and testing for items 3 and 4.

In some embodiments, items chosen to contrast with the item being tested may be selected randomly. In other embodiments, items chosen to contrast with the item being tested may be chosen for a variety of other purposes. For example, “confuser” items, such as items 1 and 2 for “Pear” and “Apple”, respectively, in FIG. 4, are selected to make a test harder and/or to find out additional information about what a user knows as aforementioned. Non-confusing items, such as items 3 and 4 for “Pumpkin” and “Celery”, respectively, in FIG. 4 are tested with the tested item 2 to make a test easier. As in FIG. 4, “Celery” is a vegetable and not a fruit, and the test is easier when adding context to eliminate choices and/or to passively test knowledge on the differences between fruit and vegetables. The N items selected are items that employ similar or different knowledge in relation to the correct answer depending on the desired difficulty of the test. Some items being tested need an extended and carefully constructed set of tests to convey the meaning and actively and/or passively assess if a user has learned the item, especially for the first time.

In accordance with at least one embodiment, a test includes path level assessment where important items are brought back into a review and testing based on a user's needs. Path level assessment utilizes information on a large scale with the idea that a user may not require mastery of every item of information but instead requires knowledge of most of the items in a review and testing. For example, if a user gets 90% of the test correct, then the user passes the review on the whole. A test keeps track of the scores for the individual items used in the large scale test. If a user keeps incorrectly getting the same item or items wrong even though a user may pass the large scale test, then the test may remediate the wrong item or items for further review and testing, or a test may provide differential diagnosis challenges to test all dependencies related to the wrong answer to isolate the source of the wrong answer and remediate the information pertaining to the source of the wrong answer accordingly.

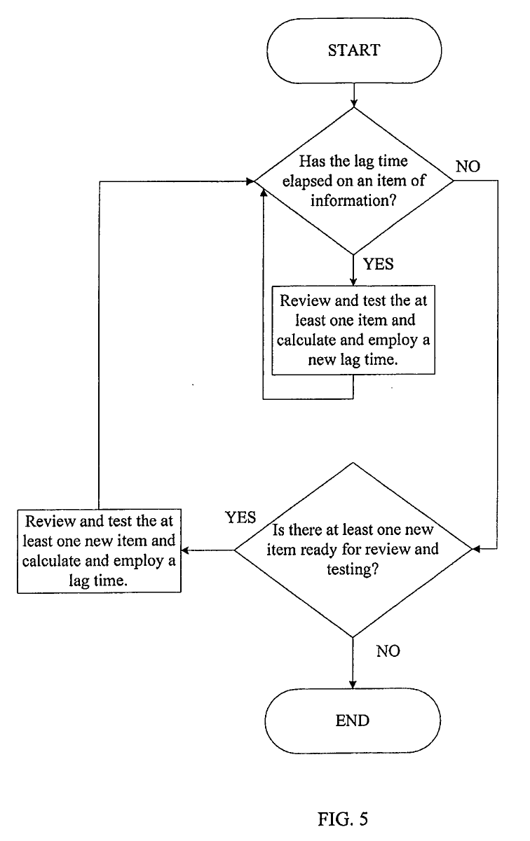

In accordance with at least one embodiment, one or more system programs employ a lag or adaptive recall method as a core engine. Now referring to FIG. 5, in accordance with at least one embodiment of the present invention, at least a program driven by a lag or adaptive recall core engine follows a disclosed method for delaying the review and testing of any item of information. First, one or more programs determine if there is at least an item of information to review and test, i.e., if the lag time on any item of information has elapsed. If yes, then the one or more programs review and test a user again on the at least one item of information, and a new lag time for the at least one new item is calculated and employed. If no, then the one or more programs determine if there is at least one new item of information to be reviewed and tested. If no, then the one or more programs quit. If yes, then the at least one new item is reviewed and tested and a lag time is calculated and employed. The one or more programs then check again to see if any item of information has a lag time that elapsed. In another embodiment, one or more programs prompt the user to continue or quit review and testing of at least one item of information.

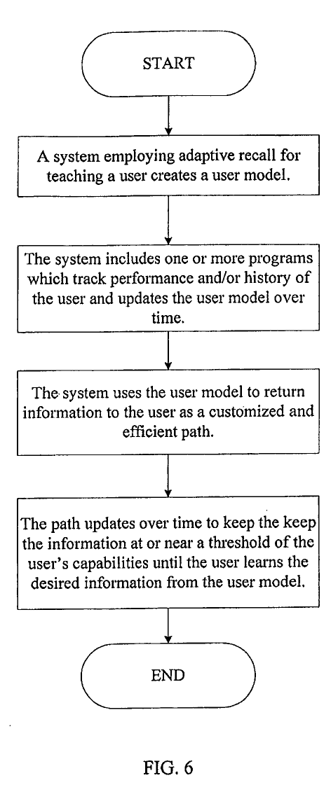

In a preferred embodiment, now referring to FIG. 6, a lag-based learning system, i.e., a system employing adaptive recall for teaching at least a user, creates and updates a user model, tracking a user's performance and/or history on selected information over time. The lag-based learning system uses the user model to return information to the user to reach the learning objective efficiently. In at least one embodiment, a lag-based learning system employs one or more programs to create and/or update a user model. A user model includes different types of information, such as, but not limited to, a number of correct and incorrect responses, a number of times a user has encountered the content and in what context, the speed of response, patterns of correct or incorrect responses, a user's desired learning objective, i.e., desired level of knowledge, or the like. In some embodiments, one or more programs in a lag-based learning system may have a pre-determined learning objective. In other embodiments, one or more programs may ask a user for the desired learning objective. The lag engine uses information in a user model to customize a path or program for the user. In some embodiments, the customized path may include parameters, such as, but not limited to, customizing the sequence of items presented to the user for learning, the order in which the items are presented, the time when or between when the items are presented, or the like. The result is a customized user experience that updates to keep the information at or near the threshold of the user's capabilities, always advancing the user's level of knowledge until the user reaches the desired level of knowledge for the information in the user model.

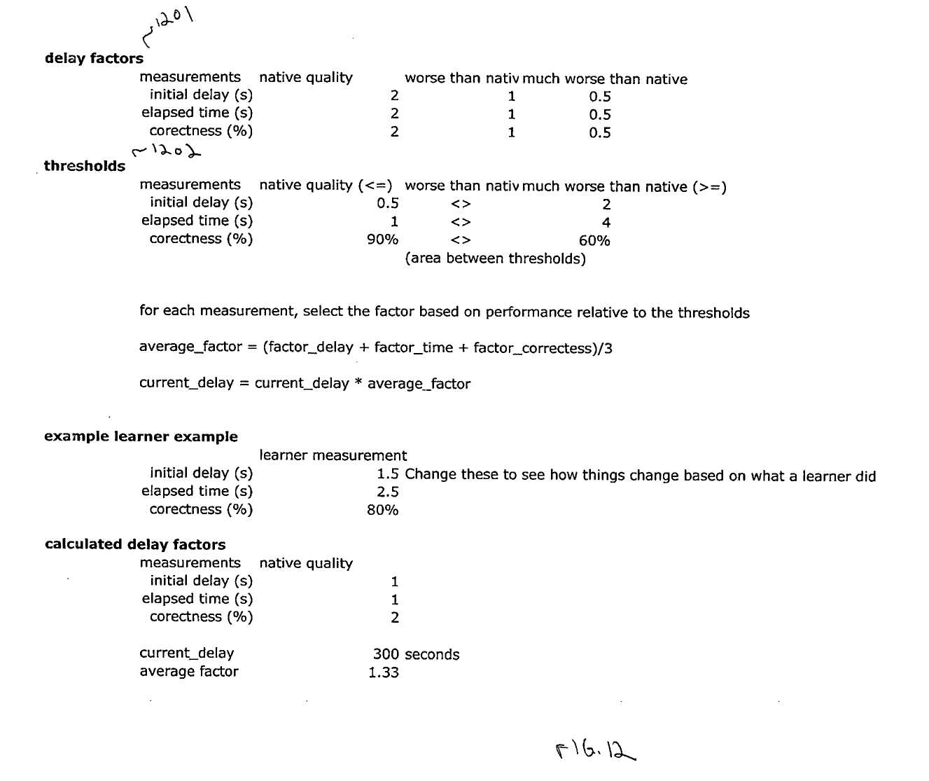

FIG. 12 is an example of how to adjust the delay after which certain subject matter will be tested. Delay factors 1201 represent how long it takes a user to answer a question (initial delay), the amount of time the answer takes (i.e.; does the user speak slowly demonstrating lack of fluency, or does the user speak at natural speed (elapsed time)), and correctness (is there a heavy accent, wrong syllable emphasized, etc). Each of the three items is graded with a number higher or lower than 1, wherein 1 is normalized to be that native speaker, or a predetermined level of fluency to representing the goal of the learner. When the user responds to questions, his delay, time to respond, and correctness are measured, and, as shown in FIG. 12, a weighted average of the three may be formed. Then, the current delay representing how long to wait before testing again, may be adjusted up or down as indicated in FIG. 12, by applying a fraction. As can be appreciated from the exemplary values in FIG. 12, the system tends toward testing the item after a longer delay, as the user gets to know the item better, hence moving it from short to longer term memory as the user learn it.

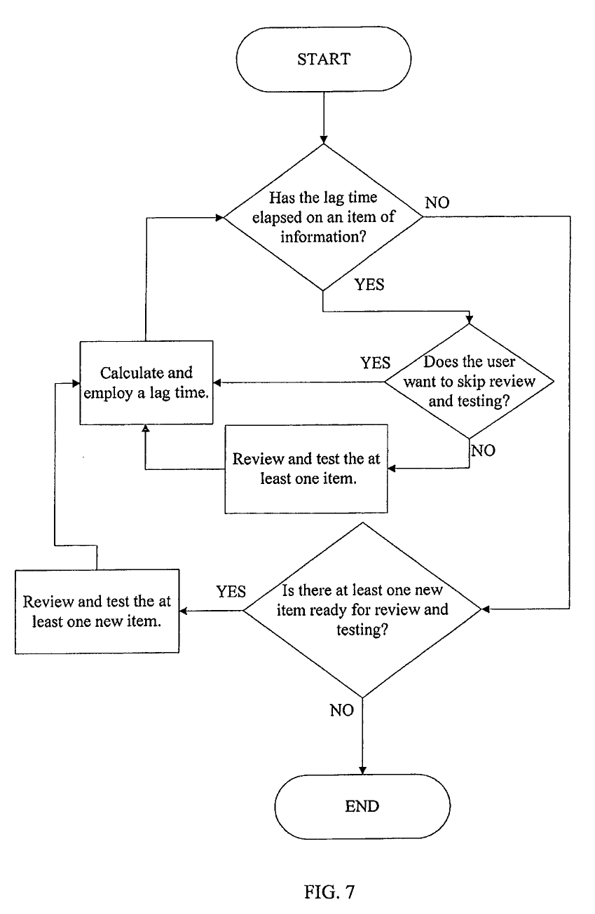

Now referring to FIG. 7, in accordance with at least one embodiment, a lag-based system includes a user interface for overriding adaptive recall time or lag time. When a user does not use a lag-based system for an extensive period of time, lag times for multiple items may lapse. As such, when a user returns to continue learning with the lag-based system, a user has to go through continuous tests to confirm that the user did not forget items and/or to refresh the user's level of knowledge. For example, a user learns for 6 months and has 300 items in the user model. The user goes away for 6 months. When the user returns, all 300 items are ready to be tested. A user normally would have to test all the old items before getting any new items of information. However, not all users would tolerate such testing. As shown in FIG. 7, in accordance with at least one embodiment, a user interface allows a user to bypass at least one review and test at a time. A lag-based system has have a “skip review and testing” option where a user does not have to wait for a specific amount of time to elapse before going on to new material. As a result, a user will review and test as much lagged items at that time as the user wants but will also allow the user to get to new items of information as desired. However, testing is forced where new items depend from old items requiring review and testing and/or where a rule requires review of more information at that time. For example, a lag-based system can have a rule imposing a time limit for review and testing. After the time limit lapses, the user interface tells the user that “There is more to review and test. Continue or move on to new material?” If a user selects review and test, the user gets additional time at most equaling the time limit for review and testing. If the user selects to move on to new material, the user is done reviewing and testing old material for the user session and moves on to new material. In some embodiments, a user may skip review and testing of a new item to get back to old items or other new items. Once a user quits the one or more programs of a system and comes back to the one or more programs later for a new session, the one or more programs can prompt the user for more review and testing of skipped and/or additional old items until the user finishes reviewing and testing the items as needed.

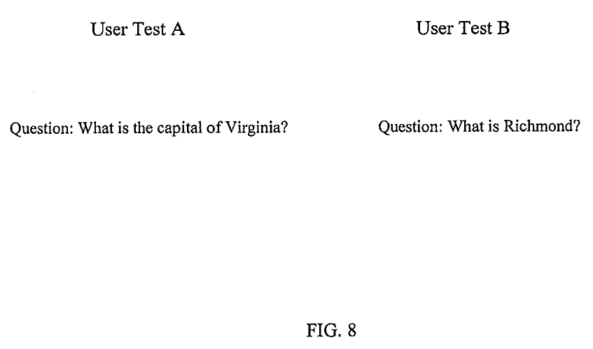

In accordance with at least one embodiment, a user model includes an extension for teaching multi-dimensional levels of knowledge, i.e., phases of information. Items of information are learned along a continuum from short term to long term memory. In some embodiments, if a user can successfully respond to a test after a certain amount of time has elapsed, the user “knows” the information and may remove the item from the list of items to review and test. However, in other embodiments, the information is more complex. Now referring to FIG. 8, in accordance with at least one embodiment, two tests present two related questions: “What is the capital of Virginia?” and “What is Richmond?”, respectively. Although the information in both questions is related, the language and answer to one question is more complex than the other language and answer to the second question. A user employs multi-dimensional levels of knowledge to answer both questions. A user may find the first question harder because a user can recognize the term “Richmond” rather than recall the term from short and/or long term memory based on a description of the term. A question is harder to answer when an item of information is not at a user's production phase, i.e., the item is known but not usefully known in a language context. In at least one embodiment, testing an old item at the existing phase increases long term memory. Attempting an old item from one phase to the next increases skill and/or proficiency.

In accordance with at least one embodiment, at least one multi-dimensional level of knowing an item exists, and a record of it is maintained in the software of the system. These levels could include, recognizing an item in strong context, recognizing an item without context, producing an item in strong context, and producing an item without context.

Referring to FIG. 8, a user being tested in phase 2 more easily recognizes the term “Richmond” without context than when the user has to produce the term “Richmond” when given strong context and asked for the capital of Virginia in phase 3. In strong context includes, but is not limited to, visual cues, meaning of an item, surrounding words and/or associations, or the like. Without context includes, but is not limited to, situations where an item is in isolation or the like. Increasing levels of knowing, i.e. difficulty, while testing moves a user from a first phase of little or no knowledge to the last phase of desired competency and/or mastery.

When a user can produce an item beyond a certain pre-selected threshold or level of knowledge, e.g., without strong context, the user is considered fluent with a particular item. When a user moves successfully to phase 4, i.e., production without context, the user may have achieved a goal for long term memory development among other goals depending on the user's desired level of knowledge. In some embodiments, learning a phase may require progression through at least another phase. In at least one embodiment, a user may be required to pass at least one phase before an item of information from the phase becomes available for another phase. In some embodiments, part of each phase may involve modeling whether a user is being tested for and/or employing a long term memory ability. In at least one embodiment, a user being tested on at least one item of language-related information may be required to pass preliminary phases for receptive and/or expressive language with and/or without context before receiving the items of information in a real-life, communicative language competency test. Degree of contextual involvement in a user model is dependent upon the needs and/or desires of a user.

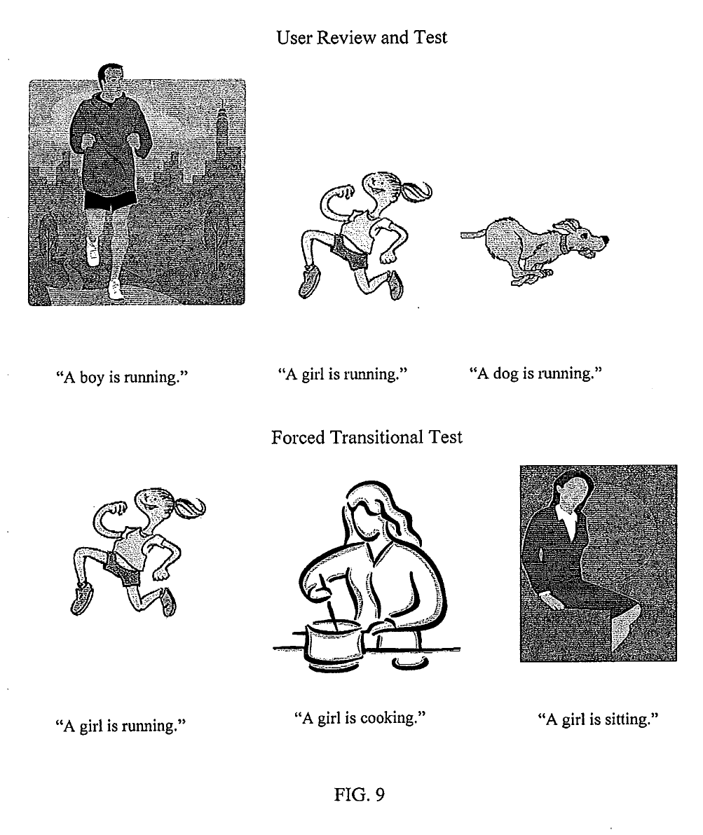

Optionally, a transitional test is employed to help a user transition from one phase to another phase. After information is introduced and practiced for retention, a test forces items of information on a user to determine how a user is doing. In some embodiments, several versions of forcing may be employed to determine whether a user knows information in the desired way. Now referring to FIG. 9, three images of a boy running, a girl running, and a dog running are presented to a user along with phrases in a target language describing each image: “A boy is running.”, “A girl is running.”, and “A dog is running.”, respectively. The test depends on “boy”, “girl”, and “dog”. The test possibly depends on verb forms the user knows. A user correctly matches the phrases with the images because the user already learned the verb form and the words for “boy”, “girl”, and “dog”. However, through testing, the user is passively introduced to the new item of information and visuals for the verb “running”. In some embodiments, additional tests may be used to reinforce a new item of information. At some point during the user's session, a transitional test, shown in FIG. 9, forces review of the new item of information for “running” by presenting images of a girl running, cooking, and sitting and asking the user to match the images with phrases: “A girl is running.”, “A girl is cooking.”, and “A girl is sitting.” In this case, a user must recognize “running” in context to pass the phase.

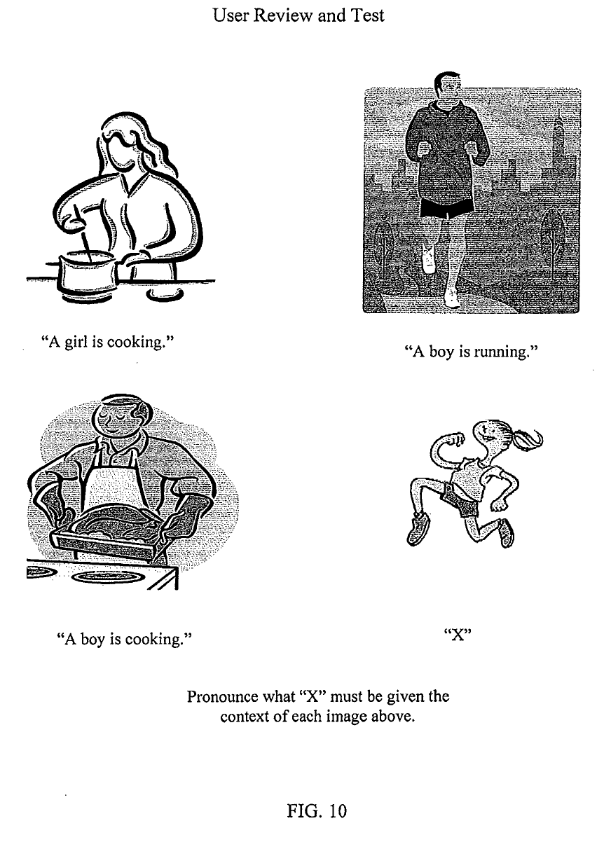

A subsequent phase or phases require a user to answer harder questions. Now referring to FIG. 10, a next phase of the phases shown in FIG. 9 presents “girl cooking”, “boy running”, “boy cooking”, and “X” with respective associated images for the first three phases and an image of a girl running for “X” to the user. The items of information are presented with strong context. The test asks the user to articulate out loud the phrase that “X” must be given the context. In some embodiments, the test in FIG. 10 may become harder when occurring without the user taking the test in FIG. 9 or when more time separates the tests of FIGS. 9 and 10.

In accordance with at least one embodiment, a user model creates at least a partially static path of phases for a user to review and test in an offline mode where a user is not on a system, such as a computer system, or the like. Such a path is more static because a user does not change the path based on performance when taking the tests offline. An idealized path is constructed on a model of how an average user performs. In one embodiment, an average user model is created, where an average user takes a given number of repetitions to learn something in a particular phase then a given amount of time before the average user is ready for a test at another phase, etc. In another embodiment, a static path is created with a sampling approach by allowing a small set of live users go through such a method and/or system, then adjusting the information to reflect the live users' patterns of success, failure, and/or progression through the phases of development.

Now referring to FIG. 11, in accordance with at least one embodiment, a system for adaptive recall includes a processor 1; a memory 11 coupled to the processor 1 via input and output lines 5, 7; an input device, such as, but not limited to, a microphone 21, coupled to the system, such as, but not limited to, a computer 3; and a display device, such as, but not limited to, a monitor 15 for displaying the program encoded by the memory 11. The monitor 15 is coupled to the computer 3 via cable 13. A user states the test answers through microphone 21 coupled to an input port 23 of computer 3 via cable 17. Input port 23 is thereby connected to the processor 1 and memory 11 via wires 9 and 19, respectively. In accordance with one or more embodiments, the user-stated answers may either transmit directly to a processor 1 and/or memory 11 depending on program directions.

Generally, the rules used to move the items of information from short term to long term memory may include one or more of rules governing performance-time relationship, rules taken from user choices or based upon user preferences, and rules derived from modeling user responses. The user may alter the rules by accelerating the testing, causing the system's lag time to be decreased. This would be equivalent to overriding the normal curriculum for a “cram course”.

In still an additional embodiment, the rules for lag times and the sequence of items to be tested may be adjusted based upon aggregate data compiled from a population. For example, if a system may prescribe a first change in lag time when a user gets the item correct. However, if the aggregate data indicates that after a user gets the item correct, when it is brought back after the specified lag time, users almost always get it correct again, then the change in lag time should be changed to make it a bit longer. Conversely, if the aggregate data indicates that after the change in lag time, users almost always get the same item incorrect, then that lag time is being increased too much, and should be shortened.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method employing adaptive recall for teaching a user, comprising:
determining a user knowledge of an item of information to be one of at least three levels; and
calculating and employing a lag time for delaying review and testing of the item.

2. The method of claim 1, further comprising receiving a desired level of knowledge from the user.

3. The method of claim 1, wherein user knowledge is at least one of: binary; multi-dimensional; and multi-leveled.

4. The method of claim 3, wherein a multi-leveled and/or multi-dimensional user knowledge is at least one of: in context, out of context, speech, written, and production.

5. The method of claim 1, wherein lag time is increased and/or eliminated when a user gains a higher level of knowledge for the item of information and/or another supplemental item of information.

6. The method of claim 1, wherein information is at least one of: a vocabulary word; verb conjugation; sentence structure; an idiom; an inflection; a phrase; a grammatical rule; a mathematical rule; subject-related information; an embodiment of a skill; alphabet recognition and/or reproduction; pronunciation; intonation; question asking; fact retention; problem solving; and task-related.

7. The method of claim 1, wherein testing is at least one of: multiple choice, question and answer, verbal recitation, matching, speech-based, writing-based, and transitional.

8. The method of claim 1, further comprising actively and/or passively assessing user knowledge of at least one test answer of the user based on at least one of: time delay of initial response, pronunciation quality, number of guesses, choices guessed, number of times user has seen the item before, whether the answer is correct or incorrect, speech recognition, elapsed time of response, writing quality and/or grading, and whether path level assessment is involved, storing said assessment, and using said assessment in customizing a future testing activity.

9. The method of claim 1, wherein lag time increases for at least one correct test answer and decreases for at least one incorrect test answer.

10. The method of claim 1, wherein lag time is reduced to zero and/or eliminated for at least one item of at least one phase if the user requires immediate review and testing of the at least one item.

11. The method of claim 1, wherein lag time is adjusted when the review and testing require more time than the user is available and/or when the review and testing is subject to at least a rule governing at least a sequence of information.

12. A method employing adaptive recall for teaching a user, comprising:
determining a user knowledge of a first item of information;
calculating and employing a lag time for delaying review and testing of the first item; and
selecting at least a second item for review and testing that can be accomplished during the lag time of the first item, wherein the selected second item depends upon the calculated lag time and the user knowledge of the first item of information.

13. The method of claim 12, further comprising considering the lag time of the first item and/or at least a dependency of the first and/or second item and/or at least a rule when selecting a second item for review and testing.

14. The method of claim 12, wherein at least one type of knowledge is employed for setting lag times and/or dependencies.

15. The method of claim 12, wherein the lag time for the first item that is a word or a phrase changes if at least a second item that is tested during the lag time is at least one of: an item for a word within the phrase, and an item for a word that is confused with the word or a word within the phrase.

16. The method of claim 12, wherein the lag time is decreased to assess user knowledge when a test calls user knowledge into doubt after at least a similar sounding and/or looking item is tested during the lag time, or increased to allow the review and testing of the selected second item to finish when taking longer than the lag time of the first item.

17. A system employing adaptive recall for teaching a user, comprising:
at least a processor;
at least a memory coupled to the processor;
at least an input device coupled to the computer system; and
one or more programs encoded by the memory, the one or more programs causing the processor to:
determine a user's knowledge of a first item of information;
calculate and employ a lag time for delaying review and testing of the first item;
and/or select a second item for review and testing that can be accomplished during the lag time, wherein the second items depends upon the lag time and the first item.

18. The system of claim 17, wherein the system exists in real-time.

19. The system of claim 17, wherein the one or more programs create and update a user model to track user performance and history on selected information through time.

20. The system of claim 19, wherein the user model is adapted to create a user path and/or teach at least a phase of at least an item of information to the user.

21. The system of claim 20, wherein the user model is adapted to create at least a partially static user path for presenting at least a phase of at least an item of information for a user to review and test in an offline mode, wherein a user is not on the system when initially learning and testing and/or reviewing and testing.

22. The system of claim 17, further comprising a user interface adapted to allow the user to continue and/or delay review and the testing of the first item for at least one of: continuing a review and testing of the first item as desired; getting to a review and a testing of at least a second item; or quitting the one or more programs.

23. The system of claim 17, further comprising adjusting lag time and/or adjusting difficulty of the test by factoring in a usage time of the user obtained from at least one of: the user at the beginning of a user session, and normal usage patterns of the user stored in a user model.

24. The system of claim 17, further comprising at least a lag core engine adapted to power and/or at least partially control review and testing for the one or more programs.

25. The system of claim 22, wherein the lag core engine customizes a user path or the one or more programs for the user.

26. A method of adjusting a lag time between items to be learned comprising setting a prescribed lag time dependant upon a user's response, and adjusting that lag time using feed back from numerous users' response when that item is being learned.

27. The method of claim 26 wherein the lag time is lengthened if at least a prescribed percentage of users give a correct response.
